(19) United States
(12) Patent Application Publication
(10) Pub. No.: US 2013/0140938 A1
(43) Pub. Date: Jun. 6, 2013

(54) BALANCED ROTOR CORE WITH REDUCED MASS AND INERTIA LAMINATIONS

(71) Applicants: Edward L. Kaiser, Orion, MI (US); Peter Bostwick, Rochester, MI (US)

(72) Inventors: Edward L. Kaiser, Orion, MI (US); Peter Bostwick, Rochester, MI (US)

(73) Assignee: GM GLOBAL TECHNOLOGY OPERATIONS LLC, Detroit, MI (US)

(21) Appl. No.: 13/425,824

(22) Filed: Mar. 21, 2012

Related U.S. Application Data
(60) Provisional application No. 61/567,090, filed on Dec. 5, 2011.

(51) Int. Cl. H02K 1/22; H02K 15/02

(52) U.S. Cl. 310/216.117; 29/598

(57) ABSTRACT

A rotor core configured to rotate about an axis includes a first end lamination, a second end lamination, and a middle lamination, which is disposed axially between the first end lamination and the second end lamination. The middle lamination has a plurality of first apertures, and the first end lamination and the second end lamination do not have the first apertures.

### CROSS-REFERENCE TO RELATED APPLICATIONS

This application claims the benefit of U.S. Provisional Patent Application No. 61/567,090, filed on Dec. 5, 2011, the disclosure of which is hereby incorporated by reference.

### TECHNICAL FIELD

This disclosure relates to rotors for electric machines and to methods of manufacturing or assembling rotors for electric machines.

### BACKGROUND

A stator is the stationary part of an electric machine. The stator interacts with a rotor, which is the moving or rotating part of the electric machine. The stator and rotor allow the electric machine to convert mechanical energy to electrical energy (generator mode) and to convert electrical energy to mechanical energy (motor mode).

### SUMMARY

A rotor core configured to rotate about an axis, such as in an electric machine, is provided. The rotor core includes a first end lamination, a second end lamination, and a middle lamination, which is disposed axially between the first end lamination and the second end lamination. The middle lamination has a plurality of first apertures, and the first end lamination and the second end lamination do not have the first apertures.

A method of creating a rotor core with a stamping die is also provided. At least one first end lamination is formed by feeding a common blank into the stamping die and activating a first punch set. The formed first end laminations are stacked. At least one middle lamination is formed by feeding another common blank, or a further portion of the blank strip, into the stamping die and activating the first punch set. A second punch set, which is different from the first punch set, is also activated. The first punch set and the second punch set are part of the same stamping tool. The formed middle laminations are then stacked onto the first end lamination.

At least one second end lamination is formed by feeding another common blank into the stamping die and activating the first punch set. The formed second end laminations are then stacked onto the middle laminations and the first end laminations. The first end laminations, the second end laminations, and the middle laminations may then be joined together to form the rotor core.

The above features and advantages, and other features and advantages, of the present invention are readily apparent from the following detailed description of some of the best modes and other embodiments for carrying out the invention, as defined in the appended claims, when taken in connection with the accompanying drawings.

### BRIEF DESCRIPTION OF THE DRAWINGS

FIG. 1 is a schematic, isometric view of rotor core;

FIG. 2 is a schematic, cross-sectional view of the rotor core shown in FIG. 1, taken along line 2-2;

FIG. 3 is a schematic, plan view of an end lamination of the rotor core shown in FIG. 1 and FIG. 2; and

FIG. 4 is a schematic, plan view of a middle lamination of the rotor core shown in FIG. 1 and FIG. 2.

### DETAILED DESCRIPTION

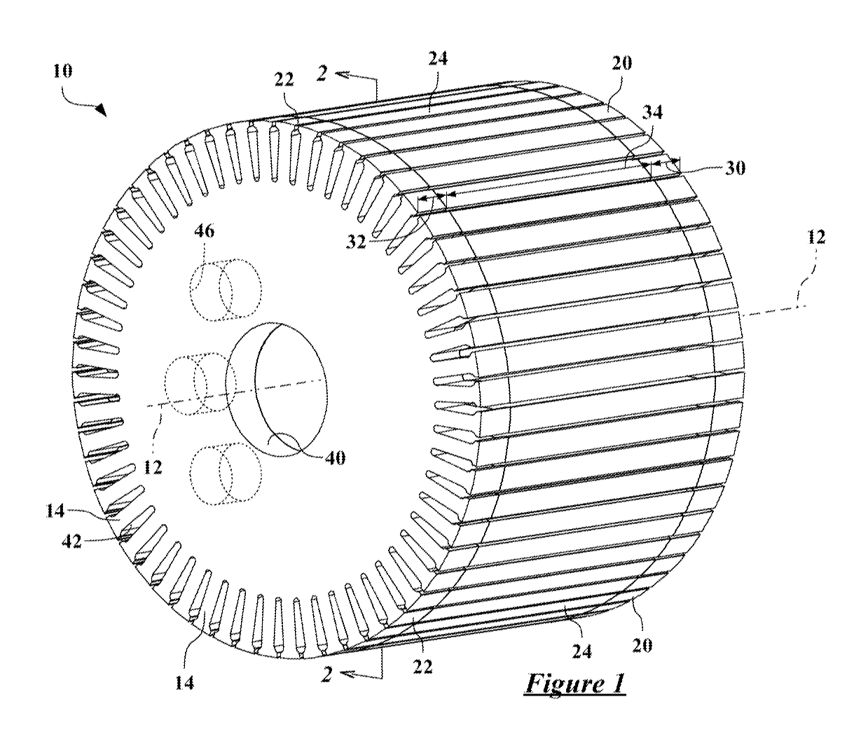

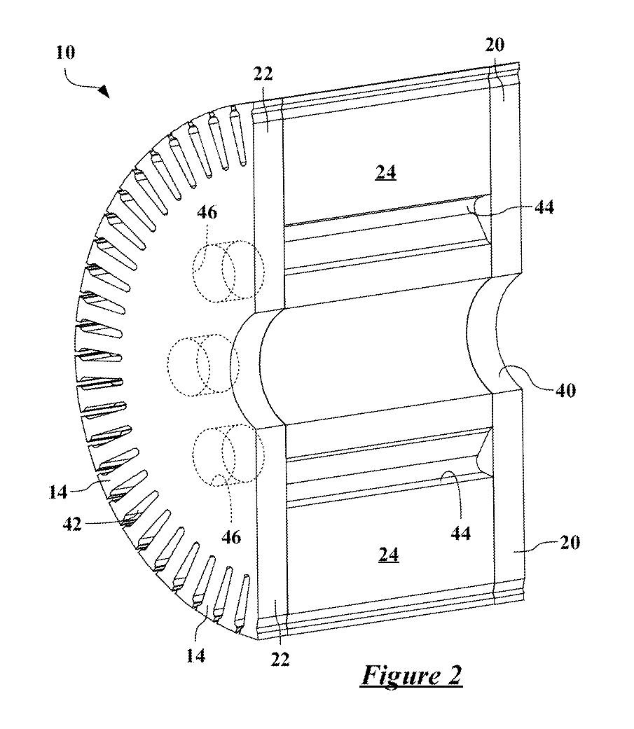

Referring to the drawings, wherein like reference numbers correspond to like or similar components whenever possible throughout the several figures, there is shown in FIG. 1 an isometric view of a rotor core 10. FIG. 2 shows a cross section of the rotor core 10, taken along a line 2-2 of FIG. 1. Features and components shown in other figures may be incorporated and used with those shown in FIG. 1 and FIG. 2, and components may be mixed and matched between any of the configurations shown.

The rotor core 10 is configured to rotate about an axis 12 within an electric machine (not shown). The axis 12 may be used to define an axial direction or axial movement that occurs generally along or parallel to the axis 12. A corresponding radial direction is perpendicular to the axis 12 and defines moving directly outward or inward from the axis 12. The radial periphery of the rotor 10 includes a plurality of rotor teeth 14. Conductive windings (not shown) may be wrapped or wound about the rotor teeth 14. Alternatively, conductive material may be die cast to the rotor core 10, such as by filling the space between the rotor teeth 14 and forming end rings (not shown) on the ends of the rotor core 10. Additional components may be added to the rotor core 10 to form a fully assembled rotor (not shown).

While the present invention may be described in detail with respect to vehicular applications, those skilled in the art will recognize the broader applicability of the invention. Those having ordinary skill in the art will recognize that terms such as “above,” “below,” “upward,” “downward,” et cetera, are used descriptively of the figures, and do not represent limitations on the scope of the invention, as defined by the appended claims.

The rotor core 10 is a laminated core, which is formed from axially-stacked laminations, as opposed to a solid core. The rotor core 10 is assembled or formed from at least one first end lamination 20 and at least one second end lamination 22, which may also be referred to simply as end laminations or end caps. At least one middle lamination 24 is disposed axially between the first end lamination 20 and the second end lamination 22.

FIGS. 1 and 2 illustrate the first end lamination 20, the second end lamination 22, and the middle lamination 24 as single components. However, many configurations of the rotor core 10 will be formed from pluralities of each of the first end lamination 20, the second end lamination 22, and the middle lamination 24. For example, and without limitation there may be two of the first end laminations 20, twenty of the middle laminations 24, and three of the second end laminations 22. Alternatively, there may be equal numbers of the first end laminations 20 and the second end laminations 22.

As shown in FIGS. 1 and 2, the rotor core 10 may be formed with the plurality of the first end laminations 20 stacked to a first axial length 30, and the plurality of the second end laminations 22 stacked to a second axial length 32. Similarly, the plurality of the middle laminations 24 may be stacked to a third axial length 34, which is different from the first axial length 30 and the second axial length 32. Note, however, that the first axial length 30 and the second axial length 32 need not be equal.

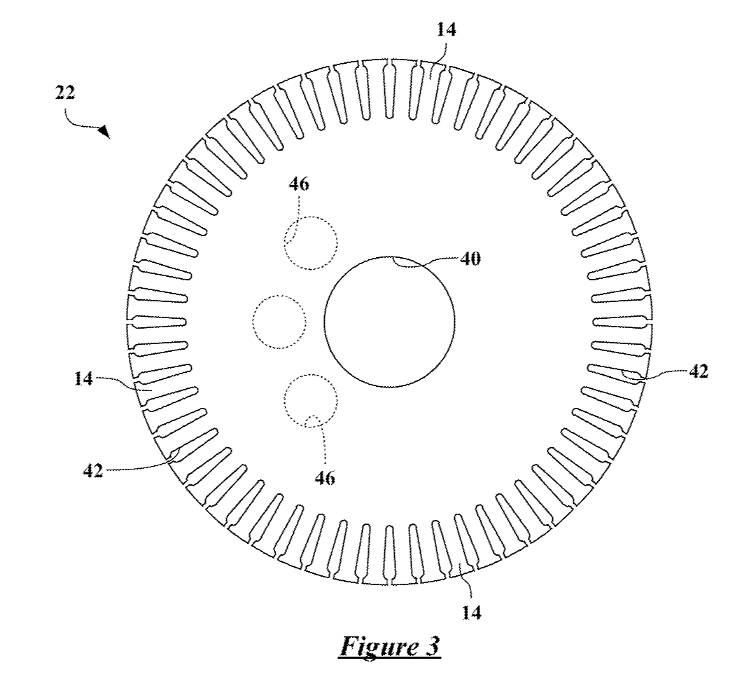

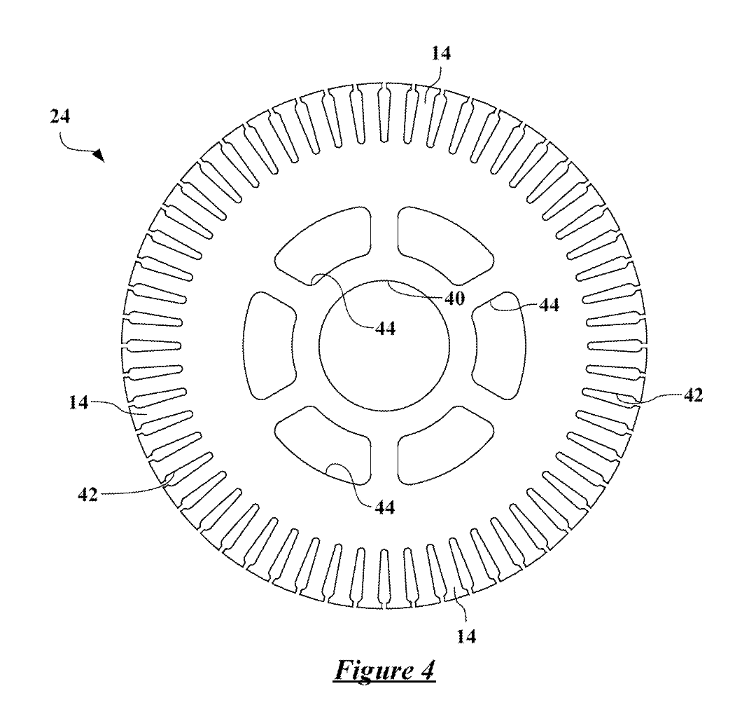

Referring now to FIG. 3 and to FIG. 4, and with continued reference to FIGS. 1 and 2, there are shown additional views of some components of the rotor core 10. FIG. 3 shows a plan view of one of the first end laminations 20 or the second end laminations 22. FIG. 4 shows a plan view of one of the middle laminations 24.

In the illustrative rotor core 10 shown, the first end laminations 20 and the second end laminations 22 are substantially identical before assembly of the rotor core 10. After assembly, the first end laminations 20, the second end laminations 22, or both, may be altered. However, the first end laminations 22 and the second end laminations 24 are not required to be identical before assembly.

The first end laminations 20, the second end laminations 22, and the middle laminations 24 may be formed by stamping or by other manufacturing processes, including machining or casting. In many instances, the first end laminations 20, the second end laminations 22, and the middle laminations 24 may be formed from discs or blanks of the same material. For example, and without limitation, the material may be steel, stainless steel, or aluminum. Alternatively, instead of individual blanks, the first end laminations 20, the second end laminations 22, and the middle laminations 24 may be formed from a continuous strip of material fed substantially continuously into the stamping die or tooling.

The first end laminations 20, the second end laminations 22, and the middle laminations 24 have a central shaft 40 formed on the interior near the axis 12. The central shaft 40 may allow the rotor core 10 to rotate independently of a journal shaft or bearing (not shown) located radially inside of the rotor core 10. Alternatively, the rotor core 10 may be mated to an output shaft (not shown) for the electric machine. A plurality of slots 42 are formed between the rotor teeth 14.

The middle laminations 24 have a plurality of first apertures 44 formed between the rotor teeth 14 and the axis 12. However, the first apertures 44 are not formed on the first end laminations 20 and the second end laminations 22. There are six of the first apertures 44 formed in middle laminations of the illustrative rotor core 10 shown. Note, however, that the number of first apertures 44 shown is not limiting.

The first apertures 44 reduce the mass and inertia of the middle laminations 24. The middle laminations 24 may also include a plurality of second apertures (not shown), which may or may not be formed on the first end laminations 20 and the second end laminations 22.

If the middle laminations 24 are formed from the same material as the first end laminations 20 and the second end laminations 22, the middle laminations 24 will have lower average density than either the first end laminations 20 or the second end laminations 22 before assembly. Furthermore, if the first end laminations 20, the second end laminations 22, and the middle laminations 24 are substantially the same thickness, the middle laminations 24 will have less mass.

At least one balance hole 46 is formed in at least one the second end laminations 22, as shown in FIGS. 1-3, or one of the first end laminations 20. The balance holes 46 may be formed after the rotor core 10 has been assembled and has been tested for balance about the axis 12. The balance holes 46 may have a depth of less than the second axial length 32, such that the balance holes 46 do not penetrate to the middle laminations 24. In many configurations of the rotor core 10, the balance holes 46 may be formed in both the first end laminations 20 and the second end laminations 22. Therefore, the balance holes 46 formed in the first end laminations 20 will have a depth of less than the first axial length 30.

Manufacturing variability or tolerances may cause the rotor core 10 to not be perfectly balanced about the axis 12. For example, differences in the common blanks or common strip material used to produce the first end laminations 20, the second end laminations 22, and the middle laminations 24 may move the center of mass or inertia away from the axis 12. Furthermore, the conductive windings and other added components impact the balance of the final, assembled rotor. Therefore, after the rotor core 10 is incorporated into the fully assembled rotor, the assembled rotor is balanced. In some instances, if the assembled rotor is sufficiently balanced, no balance holes 46 may be formed in the rotor core 10.

Removal of material by forming the balance holes 46 in either or both of the first end laminations 20 or the second end laminations 22 may improve the balance of the rotor core 10 for operation in the electric machine. By not forming the first apertures 44 in the second end laminations 22, there is more material available for removal, allowing flexibility in the location, number, and depth of the balance holes 46. The thickness of the first end laminations 20 or the second end laminations 22 may be set to provide enough material to correct for imbalance.

An illustrative or exemplary method of creating the rotor core 10 may use a stamping tool or tooling apparatus with multiple dies to cut the apertures. The exact order of the steps described may not be required and steps may be reordered, omitted, or additional steps may be included. For illustrative purposes, the method may be described with reference to the elements and components shown and described in relation to FIGS. 1-4. However, other components may be used to practice the method and the invention defined in the appended claims. Any of the steps may be executed by multiple controls or control system components.

The method may include forming at least one first end lamination 20 by feeding a common blank into the stamping tool and activating a first punch set, which causes the first punch set to advance into the common blank. The first punch set creates the common apertures, which are the central shaft 40 and the slots 42. The first end laminations 20 are then stacked, such as on a base or a jig. This portion of the method may repeat until the first end laminations 20 are stacked to a first depth, such as the first axial length 30.

Alternatively, the formed first end laminations 20 may be stacked within the die as the first laminations 20 are stamped from the common blank in sequence. As used herein, the term “common blank” refers to either individual pieces or sections of material or to a continuously fed material source, such as a long strip. Subsequent first end laminations 20 may be pressed and interlocked to previously formed first end laminations 20 during the stamping process for the rotor core 10.

The method also includes forming at least one middle lamination 24 by feeding another common blank or further portion of the common blank into the stamping tool and activating the first punch set. Unlike the first end laminations 20, for the middle laminations 24 the method includes activating a second punch set, which is different from the first punch set. Activating the second punch set causes the second punch set to advance into the common blank. The second punch set creates the first apertures 44, so that the middle laminations 24 are different from the first end laminations 20. However, note that the first punch set and the second punch set are part of the same stamping tool.

The formed middle laminations 24 may be stacked or interlocked onto the first end lamination 20. This portion of the method may repeat until the middle laminations 24 are stacked to a second depth, such as the third axial length 34. Therefore, the first end laminations 20 and the middle laminations 24 are formed by the same stamping tool or die by varying the punch sets which are actuated.

The method further includes forming at least one second end lamination 22 by feeding another common blank or additional blank material into the stamping tool and activating the first punch set. If only the first punch set is activated, the first end laminations 20 and the second end laminations 22 are substantially identical.

The formed second end laminations 22 may then be stacked onto the middle laminations 24. This portion of the method may repeat until the second end laminations 22 are stacked to the first depth, such as the first axial length 30, such that there may be an equal number of first end laminations 20 and second end laminations 22 on opposing sides of the middle laminations 24. The method may include joining the first end laminations 20, the second end laminations 22, and the middle laminations 24 to form the rotor core 10. Joining may occur after the stamping process has ended or may be a part of the stamping process, such that the first end laminations 20, the second end laminations 22, and the middle laminations 24 are joined or interlocked within the stamping tool or die.

Once the rotor core 10 is joined, the method may include testing the rotor core 10 for rotational balance about the axis 12. One or more balancing features may then be formed in at least one of the first end laminations 20 and the second end laminations 22. Forming the balancing features may include drilling the balance holes 46 in at least one of the second end laminations 22. The balance holes 46 may be drilled to less than the first depth, such that the balance holes 46 do not provide access to the first apertures 44 or the middle laminations 24 in general.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A rotor core configured to rotate about an axis, comprising:
a first end lamination;
a second end lamination; and
a middle lamination disposed axially between the first end lamination and the second end lamination, wherein the middle lamination has a plurality of first apertures formed therein, and wherein the first end lamination and the second end lamination do not have the first apertures formed therein.

2. The rotor core of claim 1, wherein the first end lamination, the second end lamination, and the middle lamination are stamped laminations.

3. The rotor core of claim 2, further comprising:
a plurality of the first end laminations stacked to a first axial length;
a plurality of the second end laminations stacked to a second axial length, substantially equal to the first axial length; and
a plurality of the middle laminations stacked to a third axial length, different from the first axial length.

4. The rotor core of claim 3, further comprising:
at least one balance hole formed in at least one of the second end laminations, wherein the balance hole has a depth of less than the second axial length.

5. The rotor core of claim 4, further comprising:
at least one additional balance hole formed in at least one of the first end laminations, wherein the additional balance hole has a depth of less than the first axial length.

6. A method of creating a rotor core with a stamping die, comprising:
forming at least one first end lamination, including:
feeding a common blank into the stamping die; and
advancing a first punch set into the common blank;
stacking the formed at least one first end lamination;
forming at least one middle lamination, including:
feeding another common blank into the stamping die;
advancing the first punch set into the common blank; and
advancing a second punch set, different from the first punch set, into the common blank, wherein the first punch set and the second punch set are part of the same stamping tool but the second punch set is not activated in forming the first end laminations;
stacking the formed at least one middle lamination onto the first end lamination;
forming at least one second end lamination, including:
feeding another common blank into the stamping die; and
advancing the first punch set into the common blank;
stacking the formed at least one second end lamination onto the middle laminations; and
joining the at least one first end lamination, the at least one second end lamination, and the at least one middle lamination to form the rotor core.

7. The method of claim 6, wherein the at least one first end lamination and the at least one second end lamination are substantially identical.

8. The method of claim 7, further comprising:
forming a plurality of the first end laminations and stacking the first end laminations to a first depth;
forming a plurality of the middle laminations and stacking the middle laminations to a second depth; and
forming a plurality of the second end laminations and stacking the second end laminations to the first depth, such that there are an equal number of first end laminations and second end laminations on opposing sides of the middle laminations.

9. The method of claim 8, further comprising:
testing the joined rotor core for balance about an axis of rotation; and
forming balancing features in at least one of the first end laminations and the second end laminations.

10. The rotor core of claim 9,
wherein forming the balancing features includes drilling balance holes in at least one of the second end laminations; and
wherein the balance holes are drilled to less than the first depth.
